(19) United States
(12) Patent Application Publication
(10) Pub. No.: US 2025/0028139 A1
(43) Pub. Date: Jan. 23, 2025

(54) ACTUATOR AND OPTICAL UNIT

(71) Applicant: NIDEC INSTRUMENTS CORPORATION, Nagano (JP)

(72) Inventors: Shogo KASAHARA, Nagano (JP); Takeshi SUE, Nagano (JP)

(21) Appl. No.: 18/777,549

(22) Filed: Jul. 19, 2024

(30) Foreign Application Priority Data
Jul. 20, 2023 (JP) 2023-118308

(51) Int. Cl. G02B 7/02

(52) U.S. Cl. CPC G02B 7/02

(57) ABSTRACT

An actuator capable of connecting a lens unit having a lens installation portion in which a lens is installed and a first connection portion with a diameter smaller than the lens installation portion, and a sensor unit having a large diameter portion with a diameter larger than the first connection portion and a second connection portion with a diameter smaller than the large diameter portion, includes a movable body having a first insertion port into which the first connection portion can be inserted from a first direction in an optical axis direction and a second insertion port into which the second connection portion can be inserted from a second direction opposite to the first direction, and a fixed body holding the movable body to be rotatable with at least one of intersecting directions intersecting the optical axis direction as a rotation axis.

### CROSS REFERENCE TO RELATED APPLICATION

The present invention claims priority under 35 U.S.C. § 119 to Japanese Application No. 2023-118308 filed Jul. 20, 2023, the entire content of which is incorporated herein by reference.

### BACKGROUND

### Field of the Invention

The present invention relates to an actuator and an optical unit.

### Description of the Related Documents

Conventionally, various optical units have been used. Among them, an optical unit including a lens unit, a sensor unit, and an actuator capable of connecting the lens unit and the sensor unit has been used. For example, Japanese Unexamined Patent Publication No. 2017-21332 discloses an optical unit including a movable body that has an imaging module provided with a lens and an imaging element and a fixed body that holds the movable body to be rotatable with a direction intersecting with an optical axis direction as a rotation axis.

In the conventional optical unit equipped with a lens unit, a sensor unit, and an actuator capable of connecting the lens unit and the sensor unit, a unit in which the lens unit and the sensor unit are fixed has been mounted on the actuator. For example, in the optical unit of Japanese Unexamined Patent Publication No. 2017-21332, the imaging module provided with a lens and an imaging element is mounted on the movable body constituting a part of the actuator. In such the configuration including the actuator capable of connecting the lens unit and the sensor unit, it is necessary to provide an insertion port though which the entire of the lens unit or the sensor unit passes, in the actuator. Therefore, the actuator is likely to be enlarged, and as a result, the optical unit is likely to be enlarged.

### SUMMARY

An actuator of at least an embodiment of the present invention can connect a lens unit having a lens installation portion in which a lens is installed and a first connection portion with a diameter smaller than that of the lens installation portion and a sensor unit having a large diameter portion with a diameter larger than that of the first connection portion and a second connection portion with a diameter smaller than that of the large diameter portion. The actuator includes a movable body having a first insertion port into which the first connection portion can be inserted from a first direction in an optical axis direction and a second insertion port into which the second connection portion can be inserted from a second direction opposite to the first direction, and a fixed body holding the movable body to be rotatable with at least one direction of intersecting directions intersecting with the optical axis direction as a rotation axis.

According to at least an embodiment of the present invention, an actuator capable of connecting a lens unit and a sensor unit can be miniaturized.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a perspective view of an optical unit according to at least an embodiment of the present invention;

FIG. 2 is an exploded perspective view showing a lens unit, a sensor unit, and an actuator of the optical unit shown in FIG. 1;

FIG. 3 is a front view showing the actuator of the optical unit shown in FIG. 1;

FIG. 4 is a front view showing a movable body of the actuator of the optical unit shown in FIG. 1;

FIG. 5 is a front view showing a fixed body of the actuator of the optical unit shown in FIG. 1;

FIG. 6 is a perspective view showing a movable body and a gimbal mechanism of the actuator of the optical unit shown in FIG. 1;

FIG. 7 is a cross-sectional view taken along a straight line A-A of FIG. 3 showing the movable body and the gimbal mechanism of the actuator of the optical unit shown in FIG. 1;

FIG. 8 is a cross-sectional view taken along a straight line B-B of FIG. 3 showing the fixed body, the movable body, and the gimbal mechanism of the actuator of the optical unit shown in FIG. 1;

FIG. 9 is a cross-sectional view seen from the front which illustrates the actuator of the optical unit shown in FIG. 1;

FIG. 10 is an exploded view seen from a side surface which shows the lens unit, the sensor unit, and the actuator of the optical unit shown in FIG. 1;

FIG. 11 is a view showing the sensor unit and the actuator shown in FIG. 10 as a cross-sectional view; and

FIG. 12 is a side view showing the lens unit, the sensor unit, and the actuator of the optical unit shown in FIG. 1 and a view showing the sensor unit and the actuator as a cross-sectional view.

### DETAILED DESCRIPTION

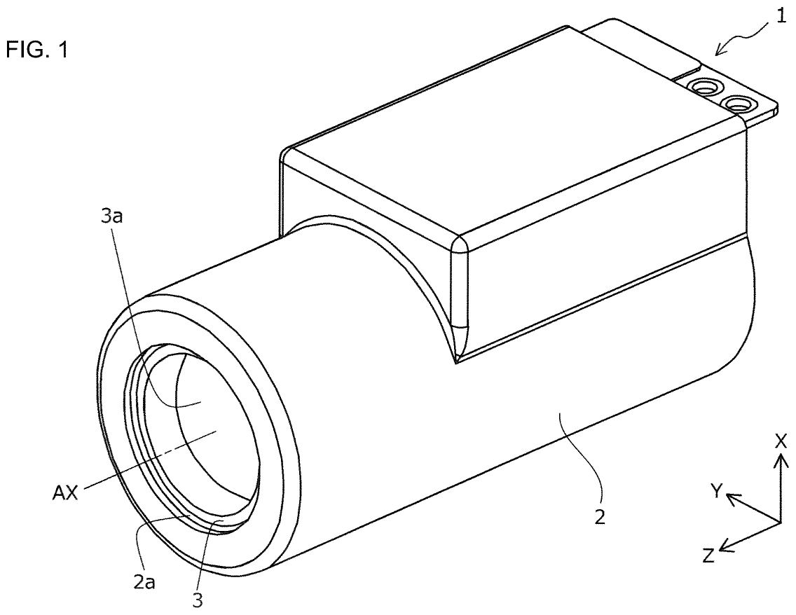

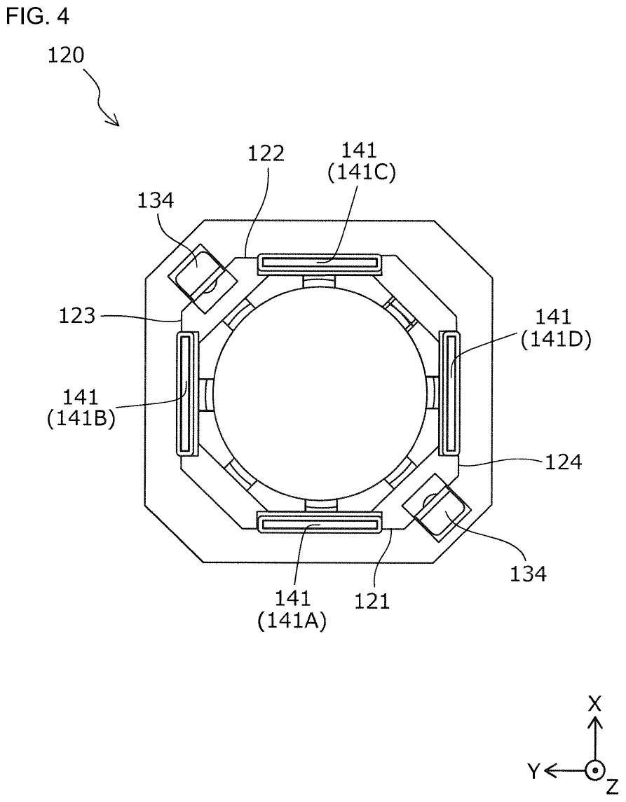

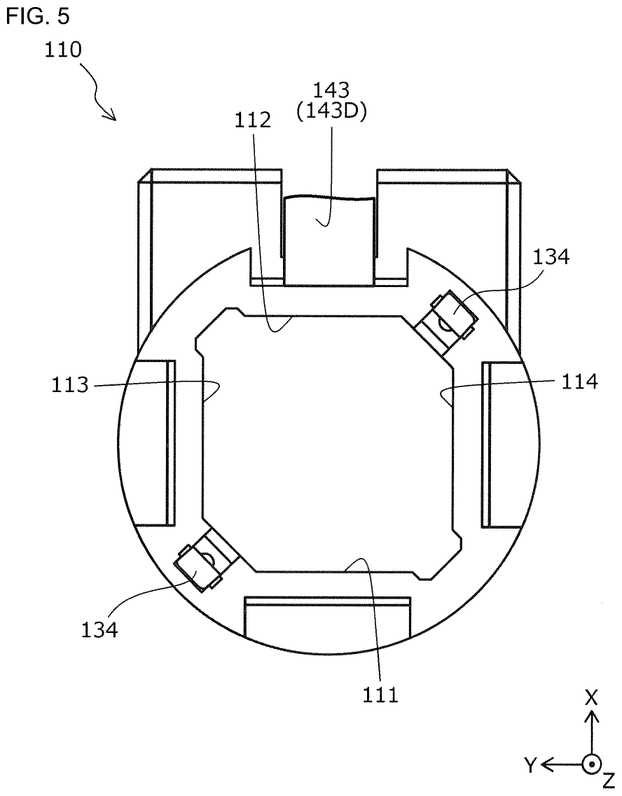

Hereinafter, an optical unit 1 according to at least an embodiment of the present invention will be described with reference to FIGS. 1 to 12. In each figure, the Z-axis direction is an optical axis direction in which an optical axis AX extends, the X-axis direction is a direction intersecting with the optical axis AX, or in other words, a yawing axis direction, and the Y-axis direction is a direction intersecting with the optical axis AX, or in other words, a pitching axis direction. Further, in the Z-axis direction, the +Z direction in which an arrow faces is the direction of the subject side and the −Z direction opposite to the direction in which the arrow faces is the direction of the anti-subject side opposite to the subject side.

### Overall Configuration of Optical Unit

First, the overall configuration of an optical unit 1 of this embodiment will be described. The optical unit 1 of this embodiment includes a housing 2 as shown in FIG. 1. As shown in FIG. 1, the housing 2 is provided with a lens unit 3 having a lens 3a.

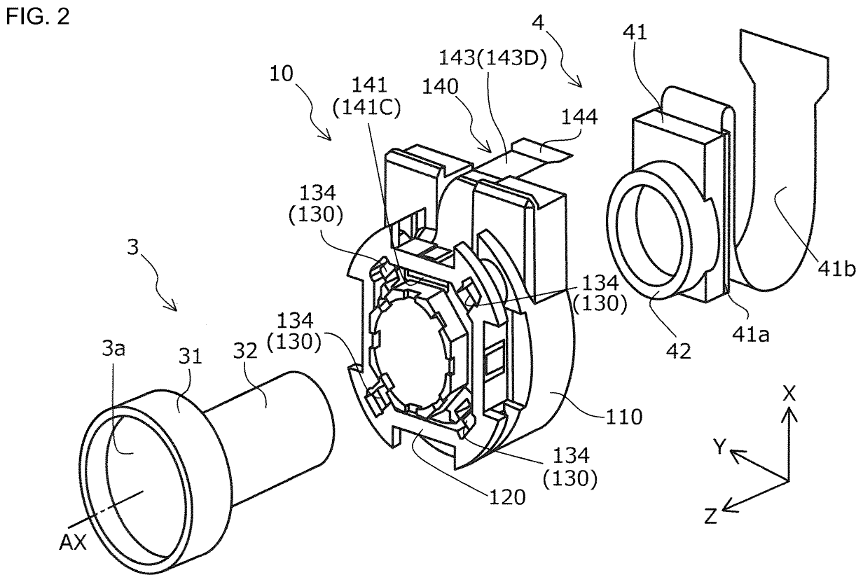

The housing 2 is provided with an actuator 10 and a sensor unit 4 as shown in FIG. 2 in addition to the lens unit 3. As shown in FIG. 1, a hole part 2a is provided in the housing 2 and the lens unit 3 is arranged in the housing 2 such that the lens 3a is visible through the hole part 2a when viewed from the optical axis direction. The actuator 10 connects the lens unit 3 and the sensor unit 4 such that the lens unit 3 can be displaced in the housing 2.

### Lens Unit

The lens unit 3 of this embodiment is connected to the actuator 10 and further connected to the sensor unit 4 while being connected to the actuator 10. As shown in FIG. 2, the lens unit 3 of this embodiment has a lens installation portion 31 in which the lens 3a is installed and a first connection portion 32 with a diameter smaller than that of the lens installation portion 31. The first connection portion 32 is connected to the actuator 10 as well as being connected to the sensor unit 4.

### Sensor Unit

The sensor unit 4 of this embodiment has a large diameter portion 41 having an imaging element 41a and a second connection portion 42 to which the first connection portion 32 is connected. Here, the first connection portion 32 is cylindrical and the second connection portion 42 is also cylindrical. Further, the first connection portion 32 and the second connection portion 42 are connected to each other such that an outer peripheral part of the first connection portion 32 is fitted to an inner peripheral part of the second connection portion 42 while the first connection portion 32 is connected to the actuator 10. A flexible substrate 41b is connected to the first connection portion 32 and the imaging element 41a.

### Actuator

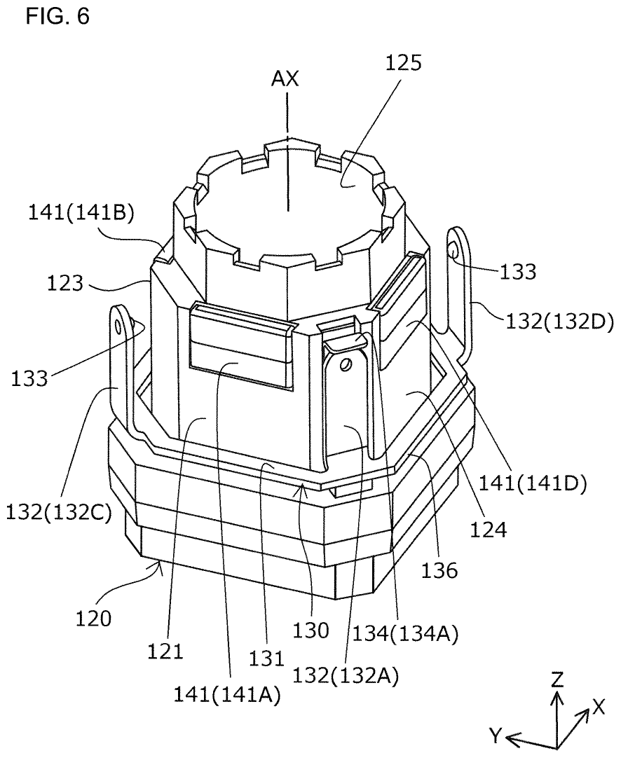

As shown in FIG. 2 and the like, the actuator 10 of this embodiment has a fixed body 110 fixed to the housing 2 and a movable body 120 that is connected with the lens unit 3 and the sensor unit 4 and is displaceable relative to the fixed body 110. The actuator 10 of this embodiment has a gimbal mechanism 130 connected to the fixed body 110 and the movable body 120 as shown in FIGS. 6 to 8, and the like.

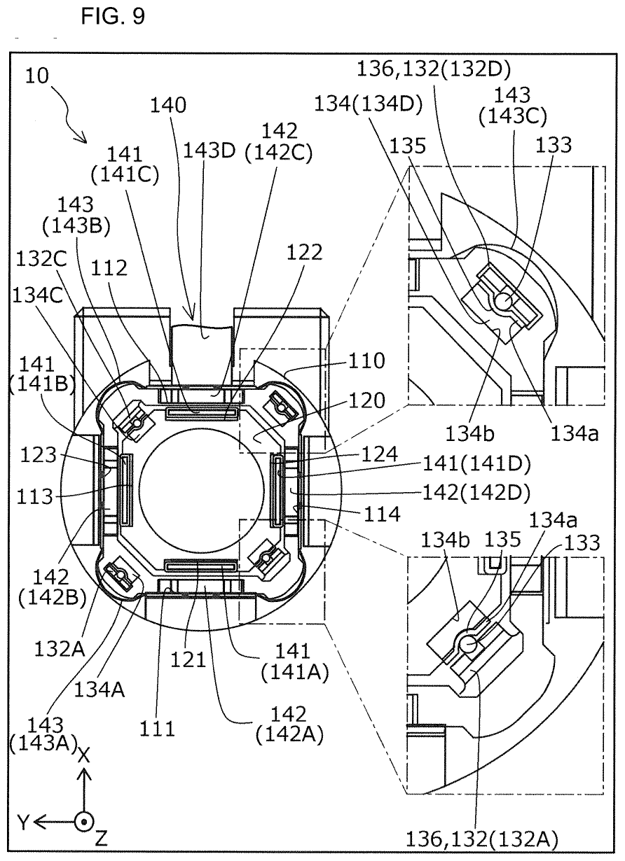

The fixed body 110 holds the movable body 120 to be rotatable with at least one direction of the intersecting directions intersecting with the optical axis direction such as the X-axis direction and the Y-axis direction as a rotation axis by the gimbal mechanism 130. Further, the actuator 10 of this embodiment has a magnet 141, a coil 142, and a flexible substrate 143 as shown in FIG. 9 and the like and also has a driving mechanism 140 that generates the driving force to rotate the movable body 120 relative to the fixed body 110. Note that, a flexible substrate 143A connecting coils 142 to each other, a flexible substrate 143B, a flexible substrate 143C, a flexible substrate 143D connected to a terminal 144 as shown in FIG. 2, and the like are included as the flexible substrate 143.

### Movable Body

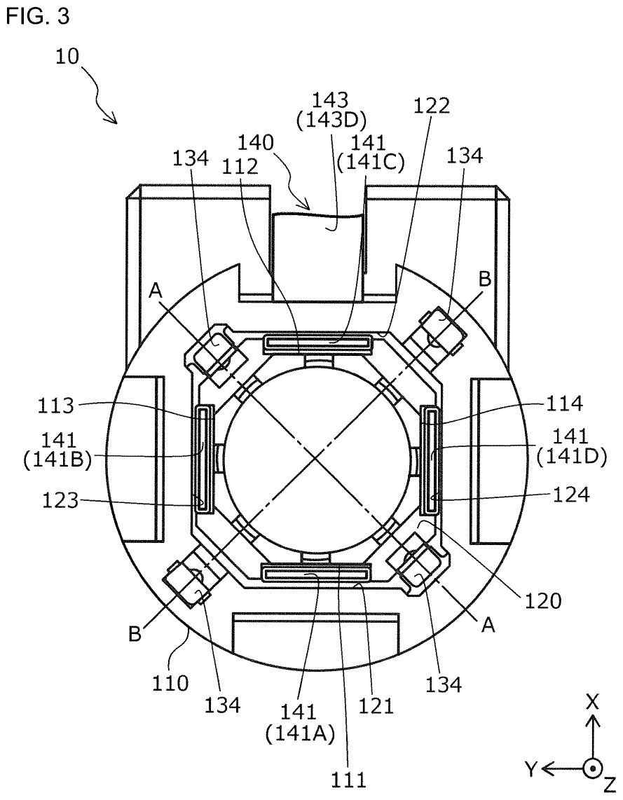

As shown in FIGS. 3, 4, 6, and 9, the movable body 120 has a first surface 121 and a second surface 122 that are parallel to the optical axis direction (the Z-axis direction) and face each other and a third surface 123 and a fourth surface 124 that are parallel to the optical axis direction, orthogonal to the first surface 121 and the second surface 122, and face each other. A magnet 141A is provided on the first surface 121 as the magnet 141, a magnet 141C is provided on the second surface 122 as the magnet 141, a magnet 141B is provided on the third surface 123 as the magnet 141, and a magnet 141D is provided on the fourth surface 124 as the magnet 141.

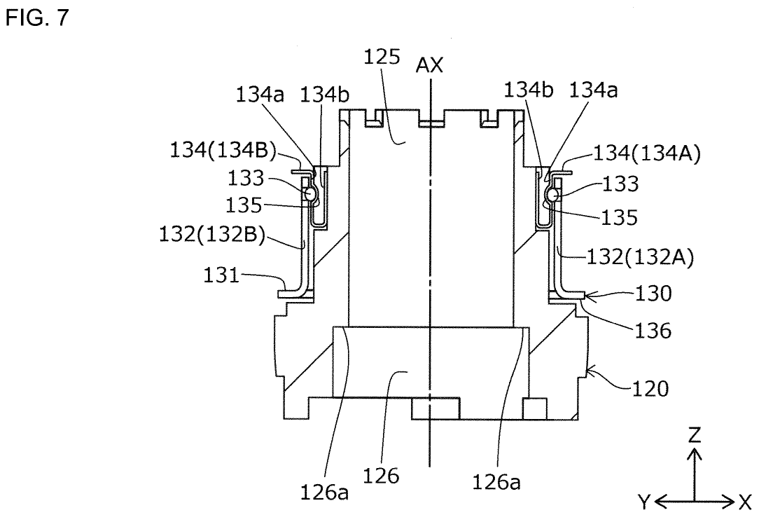

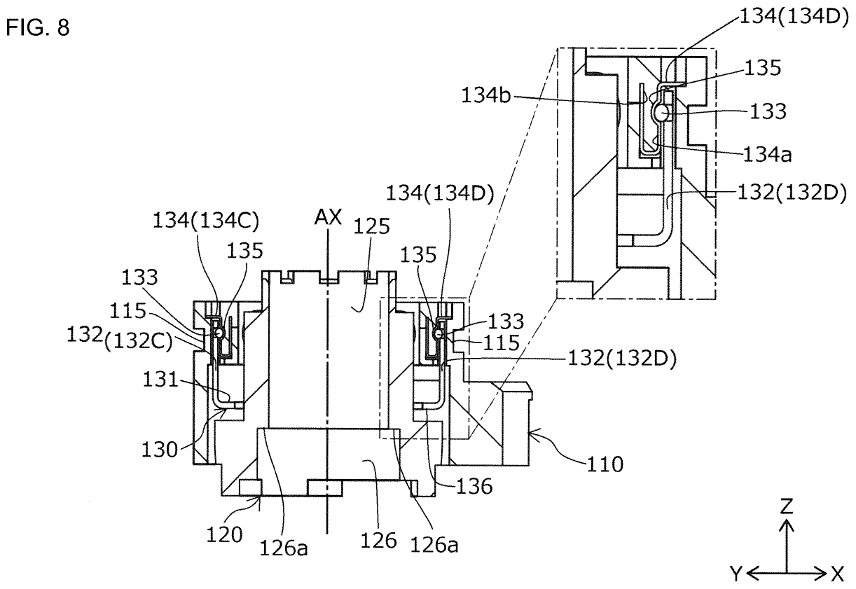

As shown in FIGS. 7 and 8, the movable body 120 has a first insertion port 125 into which the first connection portion 32 can be inserted from a first direction (the direction from the +Z direction side toward the −Z direction side) in the optical axis direction and a second insertion port 126 into which the second connection portion 42 can be inserted from a second direction opposite to the first direction (the direction from the −Z direction side toward the +Z direction side). When the movable body 120 to which the lens unit 3 and the sensor unit 4 are connected is displaced relative to the fixed body 110, the lens unit 3 and the sensor unit 4 are also displaced relative to the fixed body 110.

### Fixed Body

As shown in FIGS. 3, 5, and 9, the fixed body 110 has a first facing surface 111 facing the first surface 121, a second facing surface 112 facing the second surface 122, a third facing surface 113 facing the third surface 123, and a fourth facing surface 114 facing the fourth surface 124. As shown in FIGS. 3, 8, and 9, the movable body 120 is arranged in a region surrounded by the first facing surface 111, the second facing surface 112, the third facing surface 113, and the fourth facing surface 114 of the fixed body 110. Further, as shown in FIG. 9, a coil 142A is provided on the first facing surface 111 as the coil 142, a coil 142C is provided on the second facing surface 112 as the coil 142, a coil 142B is provided on the third facing surface 113 as the coil 142, and a coil 142D is provided on the fourth facing surface 114 as the coil 142.

Further, as shown in FIG. 8, the fixed body 110 is provided with a flexible substrate arrangement groove 115 recessed inward when viewed from the optical axis direction such that the flexible substrate 143 is arranged along the flexible substrate arrangement groove. Since the flexible substrate arrangement groove 115 is provided, it is possible to prevent the flexible substrate 143 from moving and interfering with the movable body 120 and the like when the movable body 120 is displaced relative to the fixed body 110.

### Gimbal Mechanism

As shown in FIG. 6 to FIG. 9, the gimbal mechanism 130 has a rotation member 136 that has a frame-like top plate 131 passed through the movable body 120 and four leg parts 132 extending along the optical axis direction from the top plate 131 and a support part 134 engaged with the leg parts 132 to support the leg pats 132 in a rotatable manner. The rotation member 136 has, as the leg parts 132, first leg parts 132A and 132B protruding inward of the top plate 131 when viewed from the optical axis direction and extending along the optical axis direction as shown in FIGS. 6 and 7, and second leg parts 132C and 132D protruding outward of the top plate 131 and extending along the optical axis direction as shown in FIGS. 6 and 8. Further, first support parts 134A and 134B, which are fixed to the movable body 120 to support the first leg parts 132A and 132B in the rotatable manner as shown in FIG. 7, and second support parts 134C and 134D, which are fixed to the fixed body 110 to support the second leg parts 132C and 132D in the rotatable manner as shown in FIG. 8, are included as the support part 134.

That is, the support parts 134 are provided at two locations in the fixed body 110 on an extension line of a first straight line (a straight line B-B in FIG. 3) extending to a position between the second surface 122 and the fourth surface 124 from a position between the first surface 121 and the third surface 123 when viewed from the optical axis direction and provided at two locations in the movable body 120 on an extension line of a second straight line (a straight line A-A in FIG. 3) extending to a position between the second surface 122 and the third surface 123 from a position between the first surface 121 and the fourth surface 124 when viewed from the optical axis direction. Further, as shown in FIGS. 7 and 8, each of the support parts 134 has the same configuration in which an engagement part 134a, which includes a recessed part 135 to be engaged with a protrusion part 133 provided on each leg part 132, and a fixed part 134b, which is fixed to the fixed body 110 or the movable body 120, face each other to form an U-like shape. The gimbal mechanism 130 supports the rotation member 136 by spring force of the U-like support part 134 and holds the movable body 120 to be rotatable relative to the fixed body 110. That is, the gimbal mechanism 130 of this embodiment includes the rotation member 136 having the top plate 131 with high rigidity and the leg parts 132 and the U-like support part 134 with flexibility.

### Driving Mechanism

A driving mechanism 140 of this embodiment has a magnet 141A and a coil 142A provided at a position facing the magnet 141A, a magnet 141B and a coil 142B provided at a position facing the magnet 141B, a magnet 141C and a coil 142C provided at a position facing the magnet 141C, and a magnet 141D and a coil 142D provided at a position facing the magnet 141D. Each of the magnet 141A, the magnet 141B, the magnet 141C, and the magnet 141D has the same configuration and each of the coil 142A, the coil 142B, the coil 142C, and the coil 142D also has the same configuration. A pitching shaft swing mechanism is configured by the magnet 141A and the coil 142A and the magnet 141C and the coil 142C among them. Further, a yawing shaft swing mechanism is configured by the magnet 141B and the coil 142B and the magnet 141D and the coil 142D.

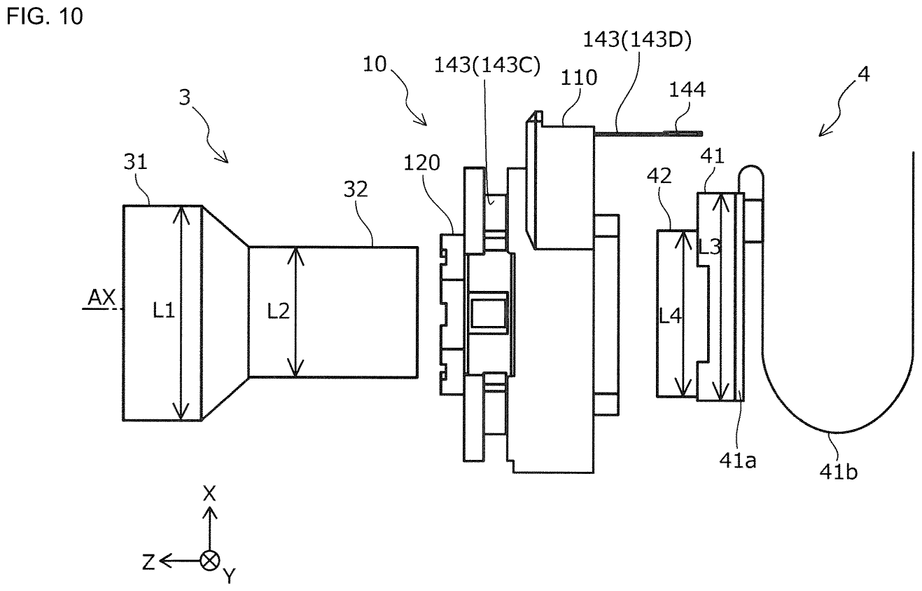

Hereinafter, the optical unit 1 of this embodiment will be described from the viewpoint of the actuator 10 with reference to FIGS. 10 to 12. The actuator 10 of this embodiment can connect the lens unit 3 and the sensor unit 4 as described above. As shown in FIGS. 10 to 12, the lens unit 3 connectable to the actuator 10 of this embodiment has a first connection portion 32 with a diameter L2 smaller than a diameter L1 of the lens installation portion 31 in which the lens 3a is installed. Further, as shown in FIGS. 10 to 12, the sensor unit 4 connectable to the actuator 10 of this embodiment has a large diameter portion 41 with a diameter L3 larger than the diameter L2 of the first connection portion 32 and a second connection portion 42 with a diameter L4 smaller than that of the large diameter portion 41.

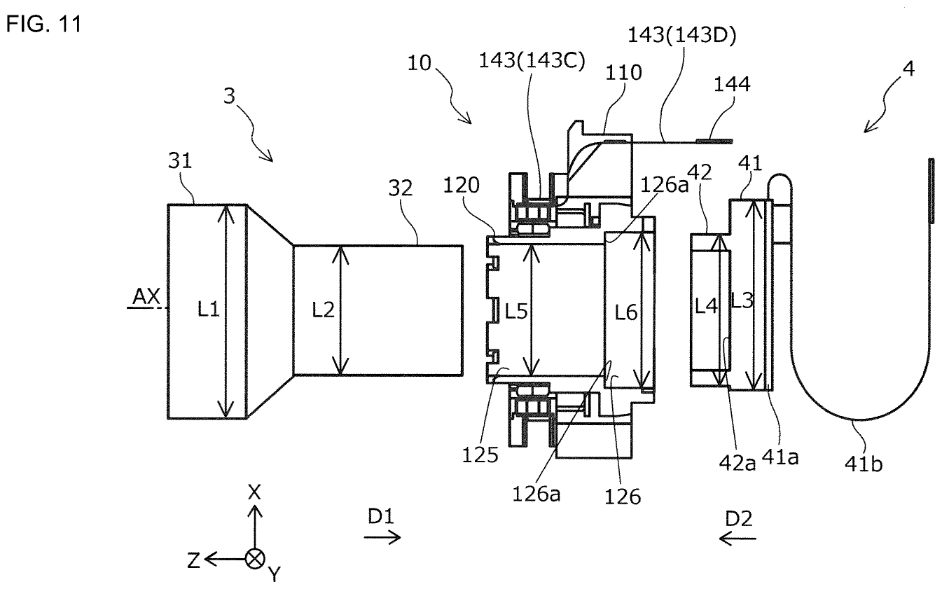

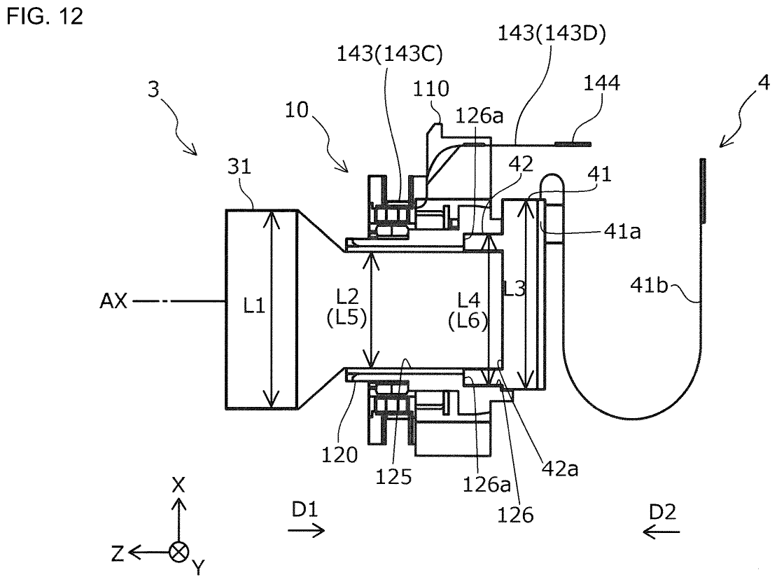

Further, as shown in FIGS. 11 and 12, the actuator 10 of this embodiment has the movable body 120 having a first insertion port 125 into which the first connection portion 32 can be inserted from the first direction D1 in the optical axis direction (the direction toward the −Z direction side from the +Z direction side) and a second insertion port 126 into which the second connection portion 42 can be inserted from the second direction D2 opposite to the first direction D1 (the direction toward the +Z direction side from the −Z direction side). As described above, the actuator further includes the fixed body 110 that holds the movable body 120 to be rotatable with at least one direction of the intersecting directions intersecting with the optical axis direction as the rotation axis.

Since the actuator 10 of this embodiment has the above-described configuration, an opening diameter L5 of the first insertion port 125 is equal to the diameter L2 of the first connection portion 32 and an opening diameter L6 of the second insertion port 126 is equal to the diameter L4 of the second connection portion 42. If employing such a configuration that the lens unit 3 and the sensor unit 4 are connected to each other and then they are mounted on the actuator 10 instead of the configuration as in this embodiment, it is necessary to provide a hole part with a diameter larger than the diameter L1 of the lens installation portion 31 and the diameter L3 of the large diameter portion 41 in the actuator 10, and this results in increase in size of not only the movable body 120 but also the actuator 10 and the optical unit 1. The actuator 10 of this embodiment having the above-described configuration can be miniaturized.

To explain the actuator 10 of this embodiment from another point of view, the first insertion port 125 has the smaller diameter than that of the lens installation portion 31 of the lens unit 3 and the second insertion port 126 has the smaller diameter than that of the large diameter portion 41 of the sensor unit 4 in the actuator 10 of this embodiment. Accordingly, the first insertion port 125 and the second insertion port 126 can be made smaller in diameter, thereby making it possible to miniaturize the actuator 10 particularly.

Further, as shown in FIGS. 11 and 12, the actuator 10 of this embodiment has a contact part 126a to which the second connection portion 42 is contacted when the second connection portion 42 is inserted in the second insertion port 126 from the second direction D2, at the second insertion port 126. The actuator 10 of this embodiment having such the configuration can accurately perform the positioning of the sensor unit 4 relative to the movable body 120 in the optical axis direction.

Further, as shown in FIG. 12, in the actuator 10 of this embodiment, the sensor unit 4 has a fitting part 42a to which the first connection portion 32 of the lens unit 3 is fitted. Therefore, the actuator 10 of this embodiment having such the configuration can accurately perform the positioning of the lens unit 3 relative to the sensor unit 4 in the optical axis direction. Furthermore, as described above, the actuator 10 of this embodiment has the configuration in which the contact part 126a is provided in the second insertion port 126 so that the positioning of the lens unit 3 relative to the movable body 120 in the optical axis direction can be accurately performed.

Finally, at least an embodiment of the present invention will be comprehensively described below.
(1)

An actuator can connect a lens unit, which has a lens installation portion in which a lens is installed and a first connection portion with a diameter smaller than that of the lens installation portion, and a sensor unit having a large diameter portion with a diameter larger than that of the first connection portion and a second connection portion with a diameter smaller than that of the large diameter portion, to each other. The actuator includes a movable body, which has a first insertion port into which the first connection portion can be inserted from a first direction in an optical axis direction and a second insertion port into which the second connection portion can be inserted from a second direction opposite to the first direction, and a fixed body holding the movable body to be rotatable with at least one direction of intersecting directions intersecting with the optical axis direction as a rotation axis.
(2)

In the actuator according to the (1) above, the first insertion port has the diameter smaller than that of the lens installation portion and the second insertion port has the diameter smaller than that of the large diameter portion.
(3)

In the actuator according to the (1) or (2) above, the actuator has a contact part to which the second connection portion is contacted when the second connection portion is inserted in the second insertion port from the second direction.
(4)

An optical unit includes the actuator according to any one of the (1) to (3) above, the lens unit, and the sensor unit.
(5)

In the optical unit according to the (4) above, the sensor unit has a fitting part to which the first connection portion is fitted.

What is claimed is:

1. An actuator capable of connecting a lens unit, which has a lens installation portion in which a lens is installed and a first connection portion with a diameter smaller than that of the lens installation portion, and a sensor unit, which has a large diameter portion with a diameter larger than that of the first connection portion and a second connection portion with a diameter smaller than that of the large diameter portion, the actuator comprising:
a movable body having a first insertion port into which the first connection portion can be inserted from a first direction in an optical axis direction and a second insertion port into which the second connection portion can be inserted from a second direction opposite to the first direction; and
a fixed body holding the movable body in a rotatable manner with at least one direction of intersecting directions intersecting with the optical axis direction as a rotation axis.

2. The actuator according to claim 1, wherein the first insertion port has a diameter smaller than that of the lens installation portion and the second insertion port has a diameter smaller than that of the large diameter portion.

3. The actuator according to claim 1, comprising:
a contact part to which the second connection portion contacts when the second connection portion is inserted in the second insertion port from the second direction.

4. An optical unit comprising:
the actuator according to claim 1;
the lens unit; and
the sensor unit.

5. The optical unit according to claim 4, wherein the sensor unit has a fitting part to which the first connection portion is fitted.
